(19) United States
(12) Patent Application Publication
(10) Pub. No.: US 2012/0180700 A1
(43) Pub. Date: Jul. 19, 2012

(54) COATING FLUID, PROCESS FOR PRODUCING SAME, AND POLARIZING FILM

(75) Inventors: Satoru Suzuki, Ibaraki-shi (JP); Shoichi Matsuda, Ibaraki-shi (JP); Sadahiro Nakanishi, Ibaraki-shi (JP); Tadayuki Kameyama, Ibaraki-shi (JP); Takuji Shintani, Ibaraki-shi (JP)

(73) Assignee: NITTO DENKO CORPORATION, Osaka (JP)

(21) Appl. No.: 13/498,925

(22) PCT Filed: Jun. 14, 2010
(86) PCT No.: PCT/JP2010/060026

§ 371 Date: Mar. 29, 2012

(30) Foreign Application Priority Data
Oct. 15, 2009 (JP) 2009-238345

(51) Int. Cl. C09D 5/00

(52) U.S. Cl. 106/287.26

(57) ABSTRACT

There is provided a polarizing film with a high dichroic ratio obtained by causing lithium ions and cesium ions to coexist at a specific ratio in a coating fluid containing a lyotropic liquid crystalline dye having an acidic group. It is presumed that the reason why the dichroic ratio becomes higher is that lyotropic liquid crystalline dyes become easier to be uniformly oriented as a result of an appropriate extension of intermolecular distance among the lyotropic liquid crystalline dyes by coupling lithium ions having a small radius and cesium ions having a large radius to an acidic group of each of the lyotropic liquid crystalline dyes in the coating fluid.

### BACKGROUND OF THE INVENTION

1. Field of the Invention

The present invention relates to a coating fluid containing a lyotropic liquid crystalline dye and a process for producing the same, and a polarizing film obtained by casting the coating fluid and followed by drying.

2. Description of the Related Art

A polarizing film is used in a liquid crystal panel to control polarization of light which passes through liquid crystals. Conventionally, a polarizing film obtained by dying a polymer film, such as a polyvinyl alcohol or the like with iodine or a dichromatic dye and stretching the film in one direction has been widely used as a polarizing film. However, there have been problems that the aforementioned polarizing film is poor in heat resistance and light resistance depending on the kind of the dye or the polymer film and has a great thickness.

In contrast, a method for forming a polarizing film by casting a coating fluid containing a lyotropic liquid crystalline dye having an acidic group, such as a sulfonic acidic group or a carboxylic acid group on a substrate, such as a glass plate or a polymer film and the like to be followed by drying is known. The lyotropic liquid crystalline dye forms supramolecular aggregates in the solution, so that the long axis direction of the supramolecular aggregates is oriented in a casting direction when casting with an application of a shearing stress onto the coating fluid containing this (JP 2006-323377 A). Polarizing films obtained in such a manner do not need to be extended. Further, the polarizing films are expected to have potential because the thickness thereof can be reduced significantly.

However, the polarizing film obtained by a coating fluid containing a conventional lyotropic liquid crystalline dye had drawbacks that the lyotropic liquid crystalline dye was not uniformly oriented and the dichroic ratio became smaller. Thus, a polarizing film which has resolved this problem has been needed.

### SUMMARY OF THE INVENTION

It is an object of the present invention to provide a polarizing film obtained from a coating fluid containing a lyotropic liquid crystalline dye having a higher dichroic ratio than conventional polarizing films.

The inventors of the present invention have found out that it is possible to obtain a polarizing film having a high dichroic ratio by causing lithium ions and cesium ions to coexist at a specific ratio in a coating fluid containing a lyotropic liquid crystalline dye having an acidic group.

The summary of the present invention is described as follows:

In a first preferred aspect, a coating fluid according to the present invention is a coating fluid for producing a polarizing film which comprises: a solvent; a lyotropic liquid crystalline dye having an acidic group; lithium ions; and cesium ions, in which the lyotropic liquid crystalline dye, the lithium ions, and the cesium ions are respectively dissolved in the solvent. The coating fluid of the present invention has a molar ratio between lithium ions and cesium ions of 3:7 (when lithium ions have a minimum quantity and cesium ions have a maximum quantity) to 7:3 (when lithium ions have a maximum quantity and cesium ions have a minimum quantity) when the total number of moles of the lithium ions and the cesium ions in the coating fluid is 10 (a relative value).

In a second preferred aspect of the coating fluid according to the present invention, the lyotropic liquid crystalline dye is an azo compound represented by the following general formula (1):

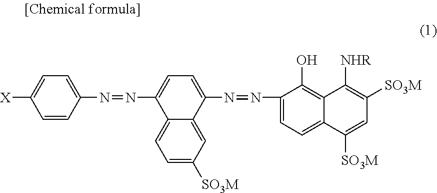

(wherein X is a hydrogen atom, a halogen atom, a nitro group, a cyano group, an alkyl group having 1 to 4 carbon atoms or an alkoxy group having 1 to 4 carbon atoms; R is a hydrogen atom, an alkyl group having 1 to 3 carbon atoms, an acetyl group, a benzoyl group, or a phenyl group (which may have any substituent group); and M is a counter ion).

In a third preferred aspect, a process for producing a coating fluid according to the present invention comprises a step of adding an alkaline solution containing lithium hydroxide and cesium hydroxide to an acidic solution containing a solvent and a lyotropic liquid crystalline dye having an acidic group dissolved in the solvent to turn the acidic solution neutral or alkaline.

In a fourth preferred aspect, a polarizing film according to the present invention is obtained by casting the aforementioned coating fluid and followed by drying.

### ADVANTAGE OF THE INVENTION

It is possible to obtain a polarizing film having a high dichroic ratio by causing lithium ions and cesium ions to coexist at a specific ratio in a coating fluid containing a lyotropic liquid crystalline dye having an acidic group.

### DESCRIPTION OF THE PREFERRED EMBODIMENTS

The inventors of the present invention have found out that a polarizing film having a high dichroic ratio is obtainable by causing lithium ions and cesium ions at a specific ratio in a coating fluid containing a lyotropic liquid crystalline dye having an acidic group. It is presumed that the reason why the dichroic ratio becomes higher is that lyotropic liquid crystalline dyes become easier to be uniformly oriented as a result of an appropriate extension of intermolecular distance among the lyotropic liquid crystalline dyes by coupling lithium ions having a small radius or cesium ions having a large radius to an acidic group of each of the lyotropic liquid crystalline dyes in the coating fluid.

### [Coating Fluid]

The coating fluid of the present invention includes a solvent, a lyotropic liquid crystalline dye having an acidic group, lithium ions, and cesium ions, which are dissolved in the solvent. Generally, such a coating fluid exhibits liquid crystallinity in a specific concentration range of the lyotropic liquid crystalline dye. Lyotropic liquid crystalline dyes are oriented when casting the coating fluid exhibiting liquid crystallinity while applying a shearing stress to the coating fluid. This makes it possible to obtain a polarizing film.

The coating fluid of the present invention contains lithium ions and cesium ions at a ratio in which the molar ratio therebetween is 3:7 (when lithium ions have a minimum quantity and cesium ions have a maximum quantity) to 7:3 (when lithium ions have a maximum quantity and cesium ions have a minimum quantity). The more the number of acidic groups in a molecular structure of the lyotropic liquid crystalline dye becomes larger, the more cesium ions are contained in the aforementioned range. Conventional coating liquids containing lyotropic liquid crystalline dyes having acidic groups remained acidic or were used after adjusting the PH with lithium hydroxide or sodium hydroxide. However, when the ion radius of cation to be bonded to acidic groups of the lyotropic liquid crystalline dyes is small, the lyotropic liquid crystalline dyes became too close to one another, which might cause the lyotropic liquid crystalline dyes to be nonuniformly oriented because a repulsive force worked.

The lithium ions respectively have an ion radius of about 76 pm (pico meter) and cesium ions respectively have an ion radius of about 190 pm. It is assumed that a distance among the lyotropic liquid crystalline dyes can be appropriately maintained by causing lithium ions and cesium ions to coexist having a molar ratio of 3:7 to 7:3. This makes it possible to obtain a polarizing film having a high dichroic ratio.

The lyotropic liquid crystalline dye in the coating fluid of the present invention preferably has a concentration of 0.5% by weight to 50% by weight. The coating fluid preferably exhibits a liquid crystal phase at least a portion in the aforementioned concentration range of the lyotropic liquid crystalline dye. While the liquid crystal phase that can be observed in the coating fluid is not particularly limited, examples thereof include a nematic liquid crystal phase and a hexagonal liquid crystal phase or the like. It is possible to confirm and observe such a liquid crystal phase by identifying optical patterns observed in the coating fluid with a polarization microscope.

The coating fluid of the present invention preferably has a pH of 5 to 10. When pH is in this range, it is possible to obtain a polarizing film with higher productivity because a metal coater, such as a stainless coater to be used at the time of casting does not easily corrode by the coating fluid.

### [Solvent]

Solvents to be used in the present invention dissolve the aforementioned lyotropic liquid crystalline dye and hydrophilic solvents are preferably used as solvents. The hydrophilic solvents are preferably water, alcohol kinds, cellosolve kinds and mixture thereof.

### [Lyotropic Liquid Crystalline Dye]

Lyotropic liquid crystalline dyes to be used in the present invention are dissolved in the aforementioned solvent and exhibit a liquid crystal phase in a specific concentration range. These lyotropic liquid crystalline dyes preferably exhibit an absorption at a visible light region (wavelength: 380 nm to 780 nm).

The lyotropic liquid crystalline dye to be used in the present invention has an acidic group to increase solubility in a hydrophilic solvent. Examples of the aforementioned acidic group include a sulfonic acidic group, a carboxylic acid group, and a phosphate group or the like. The number of acidic groups contained in a molecular structure of the lyotropic liquid crystalline dye is preferably 1 to 4 and is further preferably 2 to 3.

The lyotropic liquid crystalline dye to be used in the present invention is not particularly limited, but an azo compound, an anthraquinone compound, a perylene compound, a quinophthalon compound, a naphthaquinone compound, and merocyanine compound or the like are used.

The lyotropic liquid crystalline dye to be used in the present invention is preferably an azo compound and is further preferably an azo compound represented by the following general formula (1). In the following general formula (1), X is a hydrogen atom, a halogen atom, a nitro group, a cyano group, an alkyl group having 1 to 4 carbon atoms or an alkoxy group having 1 to 4 carbon atoms; R is a hydrogen atom, an alkyl group having 1 to 3 carbon atoms, an acetyl group, a benzoyl group, or a phenyl group (which may have any substituent group); and M is a counter ion.

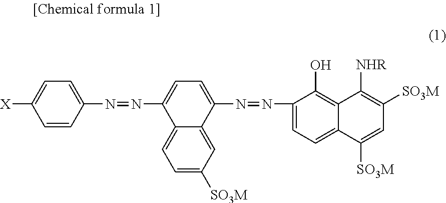

In the coating fluid, a portion of M is lithium ions and the remaining portion is cesium ions.

### [Process for Producing Coating Fluid]

A process for producing a coating fluid of the present invention includes a step of adding an alkaline solution containing lithium hydroxide and cesium hydroxide to an acidic solution containing a solvent and a lyotropic liquid crystalline dye having an acidic group dissolved in the solvent to turn the acidic solution neutral or alkaline. The solvent of the alkaline solvent is preferably a hydrophilic solvent, such as water, an alcohol kinds, cellosolve kinds and mixture thereof.

In the case where a lyotropic liquid crystalline dye is obtained by a portion of an acidic group or the entire acidic group as a salt type, it is preferable to separate the lyotropic liquid crystalline dye in the form of a free acid before the addition of an alkaline solution. Examples of a method for separating the lyotropic liquid crystalline dye in the form of a free acid typically include a method for adding strong acid, such as hydrochloric acid to a lyotropic liquid crystalline dye solution obtained by a salt-type or a method for treating a lyotropic liquid crystalline dye solution with a strong acid cation-exchange resin.

The alkaline solution preferably has a concentration (the total concentration of lithium hydroxide and cesium hydroxide) of 0.1% by weight to 20% by weight. Although the mixed quantity of the alkaline solution is appropriately set according to the number of acidic groups that exist in a molecular structure of the lyotropic liquid crystalline dye, the coating fluid preferably has a pH of 5 to 10, more preferably 6 to 8.

### [Polarizing Film]

A polarizing film of the present invention can be obtained by casting the aforementioned coating fluid, followed by drying. The polarizing film preferably exhibits absorption dichroism in a visible light region (at a wavelength of 380 nm to 780 nm). While it is to be understood that the casting method of the coating fluid is not particularly limited, examples thereof include a method for applying the coating fluid on a substrate, for example, by a coater and a method for developing the coating fluid on a metal drum or the like.

It is possible to orient the aforementioned lyotropic liquid crystalline dye by flowing with an application of a shearing stress in the liquid crystalline state. The lyotropic liquid crystalline dye forms supramolecular aggregates in the coating fluid. Accordingly, the long axis direction of the supramolecular aggregates is oriented in a flowing direction by flowing the coating fluid while applying the shearing stress to the coating fluid including this. In addition to the shearing stress, an orientation means may combine the shearing stress, orientation treatment, such as rubbing treatment and optical orientation or the like, and orientation by a magnetic field or an electric field.

Any drying methods, such as natural drying, reduced-pressure drying, drying by heating or the like may be used for a drying method for the polarizing film. The polarizing film is preferably dried so that the amount of the remaining solvent may be 5% by weight or lower relative to the total weight of the film.

The polarizing film of the present invention preferably has a thickness of 0.1 μm to 3 μm. And Y value in which visibility amendment was made to the polarizing film preferably has a dichroic ratio of 5 or more.

According to the present invention, it is possible to set the dichroic ratio of the polarizing film at 45 or more.

### EXAMPLES

The present invention will be more clearly understood by referring to the Examples below. However, the Examples should not be construed to limit the invention in any way.

### Example 1

In accordance with a conventional method (“Riron Seizo Senryo Kagaku” Fifth Edition (Theoretical production Dye Chemistry), Yutaka Hosoda (published on Jul. 15, 1968, GIHODO SHUPPAN Co., Ltd.), pages 135 to 152), a monoazo compound was produced by diazotizing and coupling 4-nitroaniline and 8-amino-2-naphthalene sulfonic acid. The obtained monoazo compound was diazotized by a conventional method in the same manner and was further subject to coupling reaction with 1-amino-8-naphthol-2,4-disulfonate lithium salt to obtain a rough product including an azo compound having the following structural formula (2) and salting out was carried out with lithium chloride to obtain an azo compound having the following structural formula (2):

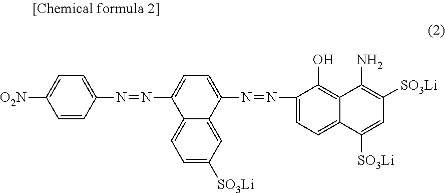

The azo compound of the aforementioned structural formula (2) was dissolved in ion-exchange water to prepare an aqueous solution of 5% by weight. Regarding this aqueous solution, an azo compound is turned to be a free acid using an ion-exchange resin (produced by OREGANO CORPORATION; product name: Amberlite IR120B HAG) and this free acid aqueous solution is adjusted to have a pH of 7.0 using an alkaline solution containing lithium hydroxide and cesium hydroxide. Water is removed from this aqueous solution by the use of a rotary evaporator to adjust the coating fluid having an azo compound of the aforementioned structural formula (2) of concentration of 20% by weight. The molar ratio between lithium ions and cesium ions in the coating fluid is 5:5.

The coating fluid was obtained with a polyethylene dropper and was sandwiched by two microscope slides. A nematic liquid crystal phase was observed when observing with a polarization microscope at room temperature (23° C.).

The coating fluid was applied on a surface of a norbornene polymer film (produced by Nippon Zeon Co., Ltd., product name “Zeonor”) with rubbing treatment and corona treatment using a bar coater (produced by BUSCHMAN, product name “Mayerrot HS4”). Subsequently, a polarizing film (with a thickness of 0.4 μm) and a laminate made of a norbornene-based polymer film were obtained by natural drying in a temperature-controlled room at 23° C. Optical characteristics of the obtained polarizing film are indicated in Table 1. Since the norbornene-based polymer film in the substrate does not substantially influence, the dichroic ratio of Table 1 is assumed to be a feature of the polarizing film.

### Example 2

A coating fluid was prepared in the same manner as in Example 1 except that the molar ratio between lithium ions and cesium ions in the coating fluid was set to 6:4. Further, a polarizing film with a thickness of 0.4 μm was formed in the same manner as in Example 1. Table 1 shows optical characteristics of the obtained polarizing film.

### Comparative Example 1

A coating fluid was prepared in the same manner as in Example 1 except that an alkaline solution containing only hydroxide lithium was used. Further, a polarizing film with a thickness of 0.4 μm was formed in the same manner as in Example 1. Table 1 shows optical characteristics of the obtained polarizing film.

### Comparative Example 2

A coating fluid was prepared in the same manner as in Example 1 except that an alkaline solution containing only hydroxide cesium was used. Further, a polarizing film with a thickness of 0.4 μm was formed in the same manner as in Example 1. Table 1 shows optical characteristics of the obtained polarizing film.

TABLE 1

| | Lithium ions:Cesium ions | Dichroic |
|---|---|---|
| | (molar ratio) | ratio |
| Example 1 | 5:5 | 51 |
| Example 2 | 6:4 | 50 |
| Comparative Example 1 | 10:0 | 43 |
| Comparative Example 2 | 0:10 | 40 |

### [Measurement Method]

### [Thickness]

A portion of a polarizing film was released to obtain the thickness of the polarizing film by measuring the level difference using a three-dimensional measurement system of the shape of a non-contact surface (manufactured by Ryoka Systems, Inc., product name: “MM5200”).

### [Observation of Liquid Crystal Phase]

A small amount of the coating fluid was obtained using a polyethylene dropper and was sandwiched by two microscope slides (manufactured by MATSUNAMI GLASS IND. LTD., Product name: “MATSUNAMI SLIDE GLASS”) to observe a liquid crystal phase at a room temperature using a polarization microscope (manufactured by Olympus; product name: “OPTIPHOT-POL”) with a large-size sample heating and cooling stage (manufactured by Japan High Tech Co., Ltd., product name: “10013L”).

[pH of coating fluid]

The pH value of the coating fluid was measured using a pH meter (produced by DENVER INSTRUMENT, product name: “Ultra BASIC”).

### [Measurement of Dichroic Ratio]

Measuring light of linear polarization was allowed to enter using a spectrophotometer with Glan-Thompson polarizer (produced by JASCO Corporation, product name: U-4100). And k₁ and k₂ of Y value whose visibility had been corrected were obtained to calculate the dichroic ratio from the following equation:

Dichroic ratio=log(1/k₂)/log(1/k₁)

wherein k₁ is a transmittance of a linear polarization in a maximum transmittance direction and k₂ is a transmittance of a linear polarization in a direction that is perpendicular to the maximum transmittance direction.

### INDUSTRIAL APPLICABILITY

The polarizing film of the present invention is preferably used as a polarizing element. A polarizing element is preferably used for liquid crystal panels for a variety of devices, such as computer displays, coping machines, mobile phones, watches, digital cameras, personal digital assistance, portable game devices, video cameras, liquid crystal television units, microwave ovens, car navigation systems, car audio systems, and a variety of monitors or the like. It is possible to use the polarizing film of the present invention while remaining laminated on the substrate and in the state of being released from the substrate. In the case where the polarizing film is used for optical uses while remaining laminated on the substrate, the substrate is preferably transparent to visible light. In the case where the polarizing film is released from the substrate, the polarizing film is preferably used while being laminated on other support or optical elements.

1. A coating fluid for producing a polarizing firm, comprising:
a solvent;
a lyotropic liquid crystalline dye having an acidic group;
lithium ions; and
cesium ions,
wherein the lyotropic liquid crystalline dye, the lithium ions, and the cesium ions are respectively dissolved in the solvent,
the coating fluid having a molar ratio between the lithium ions and the cesium ions of 3:7 to 7:3 when the total number of moles of the lithium ions and the cesium ions in the coating fluid is 10 (a relative value).

2. The coating fluid according to claim 1, wherein the lyotropic liquid crystalline dye is an azo compound represented by the following general formula (1): 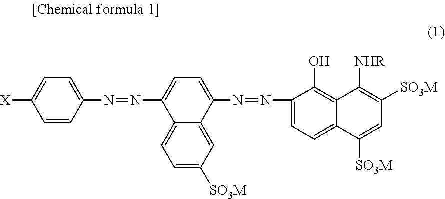
(wherein X is a hydrogen atom, a halogen atom, a nitro group, a cyano group, an alkyl group having 1 to 4 carbon atoms or an alkoxy group having 1 to 4 carbon atoms; R is a hydrogen atom, an alkyl group having 1 to 3 carbon atoms, an acetyl group, a benzoyl group, or a phenyl group (which optionally have any substituent group); and M is a counter ion).

3. A process for producing a coating fluid according to claim 1 comprising a step of adding an alkaline solution containing lithium hydroxide and cesium hydroxide to an acidic solution containing a solvent and a lyotropic liquid crystalline dye having an acidic group dissolved in the solvent to turn the acidic solution neutral or alkaline.

4. A polarizing film obtained by casting the coating fluid according to claim 1 and followed by drying.

5. A process for producing a coating fluid according to claim 2 comprising a step of adding an alkaline solution containing lithium hydroxide and cesium hydroxide to an acidic solution containing a solvent and a lyotropic liquid crystalline dye having an acidic group dissolved in the solvent to turn the acidic solution neutral or alkaline.

6. A polarizing film obtained by casting the coating fluid according to claim 2 and followed by drying.
